(19) United States
(12) Patent Application Publication
(10) Pub. No.: US 2026/0307736 A1
(43) Pub. Date: Oct. 8, 2026

(54) VEHICLE BODY LOWER STRUCTURE

(71) Applicants: HYUNDAI MOTOR COMPANY, SEOUL (KR); KIA CORPORATION, SEOUL (KR)

(72) Inventors: Jinyoung Mo, Hwaseong-si (KR); Hyeongwoon Lee, Hwaseong-si (KR); Hae Hoon Lee, Hwaseong-si (KR); Seung Min Jeong, Hwaseong-si (KR)

(73) Assignees: HYUNDAI MOTOR COMPANY, SEOUL (KR); KIA CORPORATION, SEOUL (KR)

(21) Appl. No.: 19/574,213

(22) Filed: Mar. 20, 2026

(30) Foreign Application Priority Data
Apr. 2, 2025 (KR) 10-2025-0042556
Sep. 23, 2025 (KR) 10-2025-0137248

(51) Int. Cl. B62D 25/20; B62D 25/08

(52) U.S. Cl. CPC B62D 25/20; B62D 25/08

(57) ABSTRACT

A vehicle body lower structure is provided. The vehicle body lower structure includes a rear side member disposed in a vehicle body length direction, a cross member connected with the rear side member and disposed in a vehicle body width direction, and a trailing arm mounting portion provided on the inner side of the rear side member on the outside the vehicle body width direction of the cross member and formed with a double cross-section to which a trailing arm module is mounted.

### CROSS-REFERENCE TO RELATED APPLICATION(S)

This application claims priority to and the benefit of Korean Patent Application No. 10-2025-0042556 filed with the Korean Intellectual Property Office on Apr. 2, 2025, and Korean Patent Application No. 10-2025-0137248 filed with the Korean Intellectual Property Office on Sep. 23, 2025, the entire contents of which are incorporated herein by reference.

### TECHNICAL FIELD

The example embodiment relates to a vehicle body lower structure, and more particularly, the present disclosure relates to a vehicle body lower structure capable of expanding a vehicle interior space of a vehicle body.

### BACKROUND

A low-floor platform may provide a wide vehicle interior space.

A mounting position and a mounting structure of a suspension may facilitate providing a vehicle interior space and further may provide a low-floor platform. Further, the mounting position and the mounting structure may determine the lower strength of the vehicle body.

In addition, development and use of environment-friendly vehicles is expanding as a way to combat environmental pollution.

Environment-friendly vehicles include, for example, hybrid vehicles, electric battery vehicles, hydrogen electric vehicles, and the like. The weight of the vehicle may be increased by including a high-capacity battery that stores electrical energy.

A low-floor platform for environment-friendly vehicles, for example, EV vehicles, may be useful.

The matters described in this background section are for understanding of the background of an example embodiment, and may include matters that are not already known to a person of an ordinary skill in the field to which this technology belongs.

### SUMMARY

The present disclosure provides a vehicle body lower structure capable of providing a wide vehicle interior space by implementing a low-floor platform and also capable of increasing the strength of the lower vehicle body.

A vehicle body lower structure according to an example embodiment may include a rear side member disposed in a vehicle body length direction, a cross member connected with the rear side member and disposed in a vehicle body width direction, and a trailing arm mounting portion provided on the inner side of the rear side member on the outside the vehicle body width direction of the cross member and formed with a double cross-section to which a trailing arm module is mounted.

The trailing arm mounting portion may include a trailing arm mounting bracket connected with the rear side member on the inner side of the rear side member and to which the trailing arm module is mounted, and a rear floor side upper connected to an upper part of the rear side member and forming the double cross-section together with the trailing arm mounting bracket.

The trailing arm mounting bracket may include a trailing arm inner bracket formed to protrude in a vehicle body height direction so that the trailing arm module is provided, and a trailing arm outer bracket connected with the trailing arm inner bracket to form a module mount space where the trailing arm module is mounted.

The vehicle body lower structure may further include a trailing arm mounting reinforcing portion connected to an outer side of the rear side member at a corresponding position of the trailing arm mounting portion.

The rear floor side upper may include a rear floor side upper connection portion connected with the trailing arm mounting bracket, and a rear floor side upper protruding portion formed to protrude in a vehicle body lower direction.

The rear floor side upper may include a rear floor side upper front part disposed in a front direction of the vehicle body, and a rear floor side upper rear part connected to the rear floor side upper front part and disposed behind the rear floor side upper front part.

The vehicle body lower structure may further include a seat mounting panel connected to an upper part of the rear floor side upper.

The vehicle body lower structure may further include a rear suspension support connecting the trailing arm mounting bracket and the rear side member.

The rear suspension support may be disposed toward the cross member from the trailing arm mounting bracket and is connected to the inner side of the rear side member.

The cross member may include a cross member extension having a cross-sectional shape, wherein the cross-sectional shape widens toward the trailing arm mounting portion.

The cross member may further include a cross member bulkhead mounted within (e.g., inside) the cross member extension.

The vehicle body lower structure may further include a rear side member front reinforcing portion provided on the inner side of the rear side member and disposed in front of the trailing arm mounting portion.

The trailing arm mounting portion may be formed on a curved portion where the rear side member is formed with an upward inclination in a vehicle body rear direction.

The vehicle body lower structure may further include a side member upper reinforcing portion connected to an upper part of the rear side member in the vehicle body rear direction of the trailing arm mounting portion.

In the vehicle body lower structure according to an example embodiment, a wide vehicle interior space can be provided (e.g., secured) by mounting the trailing arm module on the inner side of the rear side member.

According to the vehicle body lower structure according to an example embodiment, a low-floor platform can be provided (e.g., implemented) by mounting the trailing arm module on the inner side of the rear side member.

According to the vehicle body lower structure according to an example embodiment, the trailing arm module can be mounted without a separate bracket, so the number of parts can be reduced.

According to the vehicle body lower structure according to an example embodiment, a load transmitted from the trailing arm module can be dispersed to the vehicle body.

Other effects obtained or predicted by an example embodiment may be directly or indirectly (e.g., implicitly) disclosed in the detailed description of an example embodiment. That is, various effects of example embodiments may be disclosed in the detailed description herein.

### BRIEF DESCRIPTION OF THE DRAWINGS

Since these drawings are for reference in explaining example embodiments, the technical idea of an example embodiment should not be interpreted as being limited to the accompanying drawings.

FIG. 1 is a perspective view of a vehicle body to which a vehicle body lower structure according to an example embodiment may be applied.

FIG. 2 is a perspective view of a vehicle body lower structure according to an example embodiment.

FIG. 3 is a perspective view showing a seat mounting panel separated in a vehicle body lower structure according to an example embodiment.

FIG. 4 is a partial top plan view of a vehicle body lower structure according to an example embodiment.

FIG. 5 and FIG. 6 are exploded perspective views of a vehicle body lower structure according to an example embodiment.

FIG. 7 is a cross-sectional view taken along line VII-VII of FIG. 2.

FIG. 8 is a cross-sectional view taken along line VIII-VIII of FIG. 2.

FIG. 9 is a drawing showing load transmission of a vehicle body lower structure according to an example embodiment.

FIG. 10 is a drawing showing an operation of a vehicle body lower structure according to an example embodiment during a collision.

The drawings referenced above are not necessarily shown to scale, and should be understood to present a (e.g., somewhat) simplified representation of various features illustrating (e.g., the basic principles of) an example embodiment. For example, various design features of an example embodiment, including dimensions, directions, positions, and shapes, may be determined in part by the intended application and use environment.

### DETAILED DESCRIPTION

Hereinafter, an example embodiment will be described in detail with reference to the accompanying drawings However, an example embodiment of the present disclosure may be implemented in various different forms and is not limited to the example embodiment described herein.

In order to describe an example embodiment, parts unrelated to the description may be omitted, and like reference numerals designate like elements throughout the specification.

Since the size and thickness of each component shown in the drawings are arbitrarily shown, an example embodiment is not necessarily limited to those (e.g., sizes and thicknesses) shown in the drawings, as, for example, the thickness may be enlarged to (e.g., clearly) illustrate (e.g., express) various parts and regions.

Terminology used herein is for the purpose of describing example embodiments and is not intended to limit the present disclosure. As used herein, singular forms are intended to also include plural forms unless the context (e.g., clearly) indicates otherwise.

In addition, in the following detailed description, names of components are divided into first, second, etc., to distinguish the components in the same relationship, and the order is not necessarily limited in the following description.

In addition, terms such as “unit,” “means,” etc. described in the specification provide (e.g., mean) a unit of a comprehensive configuration that performs at least one function or operation.

When a part of a layer, film, region, plate, etc., is said to be “on” another part, this includes not only the case where it is directly on the other part but also the case where another part is in the middle.

In contrast, when an element is referred to as being “directly on” another element, there are no intervening elements present.

The terms “comprises” and/or “comprising” used in this specification indicate the presence of stated features, integers, steps, operations, elements, and/or components, but do not exclude the presence or addition of one or more other features, integers, steps, operations, components, and/or groups thereof.

As used in this specification, the term “and/or” includes any one or all combinations of one or more of the associated listed items.

In this specification, the term “coupled” or “connected” refers to a physical relationship between two components where the components are directly connected (e.g., to each other) by, for example, welding, rivet, SPR (Self Piercing Rivet), FDS (Flow Drill Screw), structural adhesive, etc., or indirectly connected through one or more intermediate components.

The terms “vehicle,” “car,” “of a vehicle,” or other similar terms used herein include vehicles including passenger vehicles including sports utility vehicles (SUV), buses, trucks, various commercial vehicles, ships including various types of boats or vessels, aircraft, and similar ones, and include hybrid vehicles, electric vehicles, plug-in hybrid electric vehicles, hydrogen fuel vehicles, and other alternative fuel (e.g., fuel obtained from resources other than petroleum) vehicles.

Herein, reference directions for describing the following components may be set to a vehicle body front-rear direction (e.g., vehicle body length direction or longitudinal direction), a vehicle width direction (e.g., left-right direction or transverse direction), and a vertical direction (e.g., height direction), with the vehicle body as a reference.

Hereinafter, an example embodiment of the present disclosure is described with respect to the accompanying drawings.

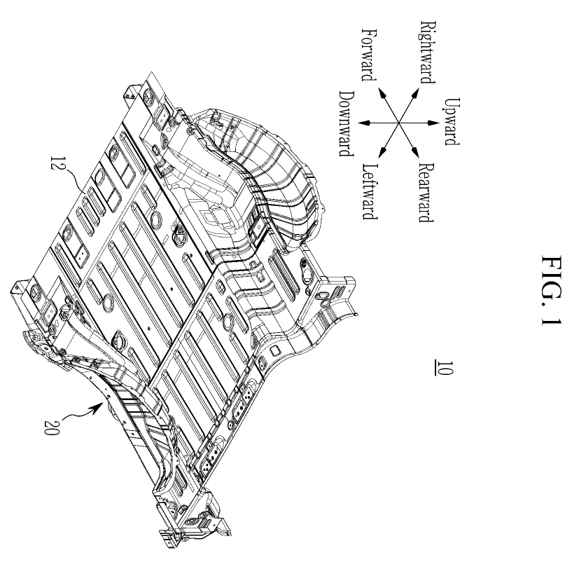

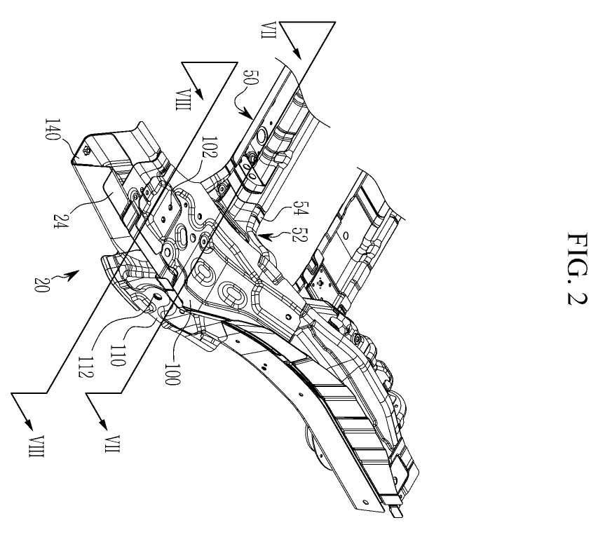

FIG. 1 is a perspective view of a vehicle body to which a vehicle body lower structure according to an example embodiment may be applied. FIG. 2 is a (e.g., partial) perspective view of a vehicle body lower structure according to an example embodiment.

In general, the load of the vehicle body may be transmitted to a rear suspension module, and it would be useful to strengthen a mount of the rear suspension module.

For example, in some vehicles, a trailing arm may be mounted using a separate bracket, according to the type of rear suspension of the vehicle.

To secure the internal space of the vehicle, lowering the base surface where the rear floor is mounted may facilitate transmitting the load of the vehicle to a rear suspension module.

The example embodiment provides a vehicle body lower structure that implements a low-floor platform by relatively lowering a position where a rear floor is mounted (e.g., with respect to the rest of the vehicle) and strengthens a portion of the lower structure where a rear suspension module is mounted.

Referring to FIG. 1 and FIG. 2, a vehicle body lower structure according to an example embodiment may include a rear side member 20 disposed in a vehicle body 10 length direction, and a cross member 50 connected with the rear side member 20 and disposed in a vehicle body width direction (e.g., a width direction of the vehicle body).

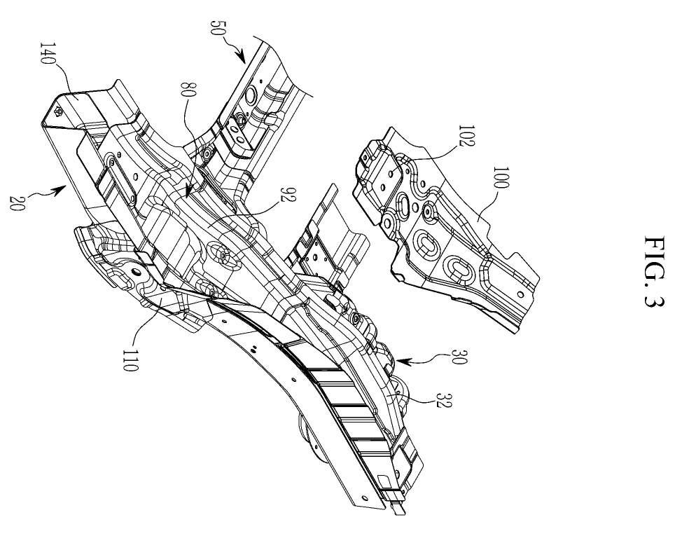

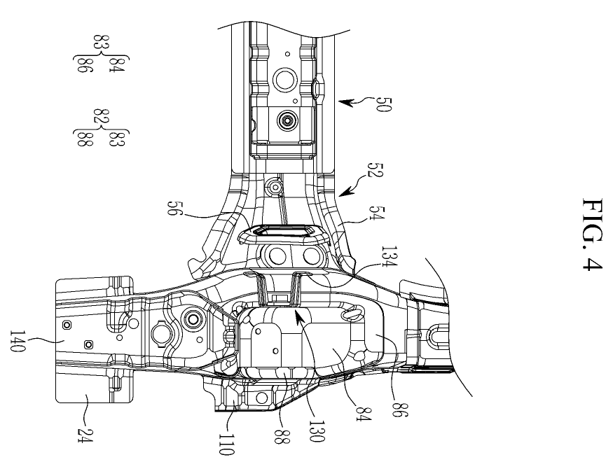

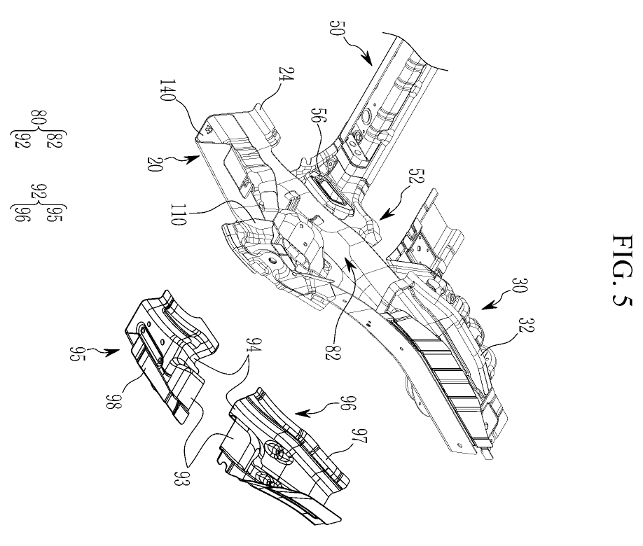

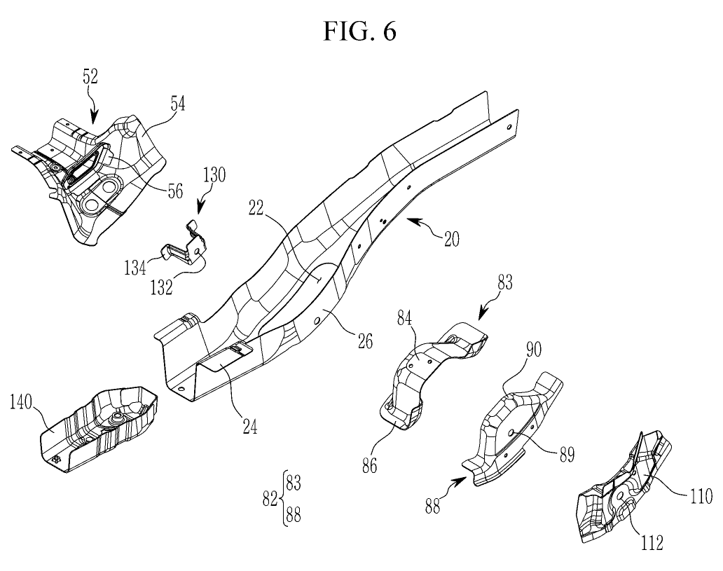

FIG. 3 is a perspective view of a vehicle body lower structure according to an example embodiment with a seat mounting panel separated. FIG. 4 is a partial top plan view of a vehicle body lower structure according to an example embodiment. FIG. 5 and FIG. 6 are exploded perspective views of a vehicle body lower structure according to an example embodiment.

Referring to FIG. 1 to FIG. 6, a vehicle body lower structure according to an example embodiment may include a trailing arm mounting portion 80 provided on an inner side of the rear side member 20, wherein the rear side member 20 is on the outside of the vehicle body in a width direction of the cross member 50. In other words, outside of the vehicle body may indicate that the trailing arm mounting portion 80 is on the inner side of the vehicle body, at a position relatively adjacent to the end of the vehicle body width.

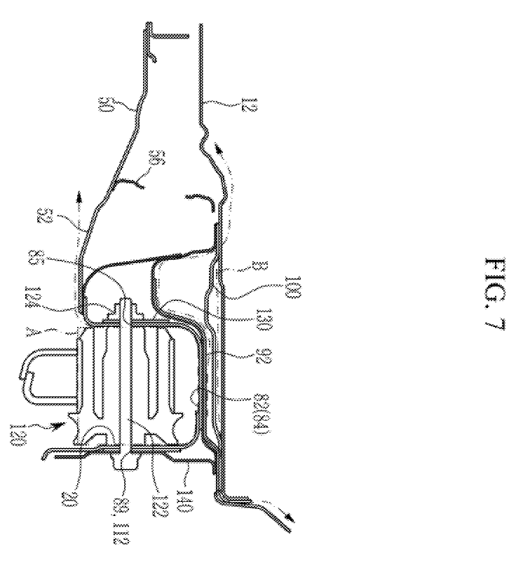

A trailing arm module 120 (see FIG. 7) is mounted on the trailing arm mounting portion 80, described herein.

Space utilization may be increased because the trailing arm mounting portion 80 is provided on the inner side of the rear side member 20, and because the trailing arm mounting portion 80 is mounted at a portion where the cross member 50 and the rear side member 20 are connected, a load transmitted from the trailing arm module 120 may be (e.g.,. appropriately) dispersed in the width direction of the vehicle body 10 and/or the length direction of the vehicle body 10.

The trailing arm mounting portion 80 may include a trailing arm mounting bracket 82 connected with the rear side member 20 on the inner side of the rear side member 20 and to which the trailing arm module 120 is mounted, and a rear floor side upper 92 connected to an upper part of the rear side member 20.

FIG. 7 is a cross-sectional view taken along line VII-VII of FIG. 2.

Referring to FIG. 1 to FIG. 7, a trailing arm module insertion hole 22 (shown in at least FIG. 6) is formed in the rear side member 20, and the trailing arm module 120 may be mounted through the trailing arm module insertion hole 22.

The rear side member 20 includes a rear side member upper flange 24, which may be curved upward, and the rear side member upper flange 24 is connected with a rear floor panel 12 to support the rear floor panel 12.

The trailing arm mounting bracket 82 may include a trailing arm inner bracket 83 formed to protrude in a vehicle body height direction (e.g., providing the trailing arm module 120), and a trailing arm outer bracket 88 coupled with the trailing arm inner bracket 83 to form a module mount space A where the trailing arm module 120 is mounted.

The trailing arm inner bracket 83 may include an inner bracket protruding portion 84 formed to protrude upward, and the trailing arm outer bracket 88 may include an outer bracket protruding portion 90 having a shape corresponding to the inner bracket protruding portion 84.

The trailing arm inner bracket 83 may include a trailing arm bracket flange 86 curved at its lower part, and the trailing arm bracket flange 86 may be connected with the rear side member 20.

The inner bracket protruding portion 84 and the outer bracket protruding portion 90 may form the module mount space A inside the protruding shape where the trailing arm module 120 is mounted.

The vehicle body lower structure according to an example embodiment may further include a rear suspension support 130 connecting the trailing arm mounting bracket 82 and the rear side member 20.

The rear suspension support 130 is disposed in the direction of the cross member 50 from the trailing arm mounting bracket 82 and connected to the inner side of the rear side member 20.

The rear suspension support 130 connects the trailing arm mounting portion 80 to the rear side member 20, and may disperse a load transmitted from the trailing arm mounting portion 80 through the rear side member 20 and the cross member 50.

For example, the rear suspension support 130 may include a suspension support flange 134 connected to the inner side of the rear side member 20, and a suspension support hole 132 may be formed in a portion connected with the trailing arm mounting bracket 82. The rear suspension support 130 may be connected with the trailing arm mounting bracket 82 through the suspension support hole 132, and the suspension support flange 134 is connected with the rear side member 20 to transmit a load transmitted from the trailing arm module 120 to the rear side member 20.

In the trailing arm inner bracket 83, an inner bracket coupling hole 85 may be formed at a position corresponding to the suspension support hole 132 of the rear suspension support 130, and an outer bracket coupling hole 89 may be formed in the trailing arm outer bracket 88.

The vehicle body lower structure, according to an example embodiment, may further include a trailing arm mounting reinforcing portion 110 connected to an outer side of the rear side member 20 at a position corresponding to the position of the trailing arm mounting portion 80. The trailing arm mounting reinforcing portion 110 reinforces a connection (e.g., part) between the trailing arm module 120 and the rear side member 20, and may support the trailing arm module 120.

A trailing arm mounting reinforcing portion coupling hole 112 is formed in the trailing arm mounting reinforcing portion 110.

The trailing arm module 120 may be mounted to the trailing arm mounting portion 80 through fasteners, for example, a trailing arm module mounting bolt 122 and a trailing arm module mounting nut 124.

The trailing arm module 120 is mounted and/or coupled to the trailing arm mounting portion 80 as the trailing arm module mounting bolt 122 passes through the trailing arm mounting reinforcing portion coupling hole 112, the outer bracket coupling hole 89, the inner bracket coupling hole 85, and/or the suspension support hole 132. A load transmitted to the trailing arm module 120 may be dispersed to the rear side member 20 through the trailing arm mounting reinforcing portion 110, the trailing arm outer bracket 88, the trailing arm inner bracket 83, and/or the rear suspension support 130.

The rear floor side upper 92 may include a rear floor side upper connection portion 93 connected with the trailing arm mounting bracket 82, and a rear floor side upper protruding portion 94 formed to protrude in a vehicle body lower direction.

For example, the rear floor side upper connection portion 93 is coupled, such as by welding, with the inner bracket protruding portion 84 of the trailing arm mounting bracket 82 to disperse a load transmitted from the trailing arm module 120 through the upper part of the rear side member 20.The rear floor side upper protruding portion 94 surrounds the trailing arm mounting bracket 82 and is formed to protrude in the rear suspension support 130 direction to disperse a load transmitted from the trailing arm module 120 to the rear side member 20 and the cross member 50.

The rear floor side upper 92 may include a rear floor side upper front part 95 disposed in a front (e.g., forward) direction of the vehicle body, and a rear floor side upper rear part 96 connected to the rear floor side upper front part 95 and disposed behind the rear floor side upper front part 95.

The rear floor side upper 92 may be provided as an integrated structure, or as shown in the drawing, may be a configuration in which the rear floor side upper front part 95 and the rear floor side upper rear part 96 are connected.

For example, configuring the rear floor side upper 92 by connecting the rear floor side upper front part 95 and the rear floor side upper rear part 96 at a portion where the rear side member 20 is curved, the connection strength of the curved configuration may be improved (e.g., secured) and a molding process of the rear floor side upper 92 may be simplified.

The vehicle body lower structure according to an example embodiment may further include a seat mounting panel 100 connected to the upper part of the rear floor side upper 92.

The seat mounting panel 100 is connected to the upper part of the trailing arm mounting portion 80 to increase the strength of the connection part, and a seat or a seat belt may be mounted. Since the seat mounting panel 100 is connected to the upper part of the trailing arm mounting portion 80 with increased connection strength, the strength for mounting a seat or a seat belt may be improved (e.g., secured).

A seat mounting panel coupling hole 102 is formed in the seat mounting panel 100 so that a seat or a seat belt may be coupled to the seat mounting panel 100 through the seat mounting panel coupling hole 102.

The rear floor side upper 92 includes side upper upper flanges 97 and 98 curved at the upper part. The side upper upper flanges 97 and 98 are connected with the seat mounting panel 100 to support the seat mounting panel 100.

The cross member 50 includes a cross member extension 52 whose cross-section shape widens toward the trailing arm mounting portion 80. The cross member extension 52 may have increased coupling strength with the rear side member 20 through formation of the cross-section, and may lower the possibility of fracture during a collision of a vehicle by preventing or minimizing concentration of a load.

The cross member extension 52 includes a cross member extension upper flange 54 curved at the upper part, and the cross member extension upper flange 54 is connected with the rear floor panel 12 to support the rear floor panel 12.

The cross member 50 may further include a cross member bulkhead 56 mounted inside the cross member extension 52. The cross member bulkhead 56 may reinforce the cross member extension 52 to increase connection strength.

The rear suspension support 130 is disposed from the trailing arm mounting bracket 82 toward the cross member 50 to disperse a portion of the load transmitted from the trailing arm module 120 toward the cross member 50.

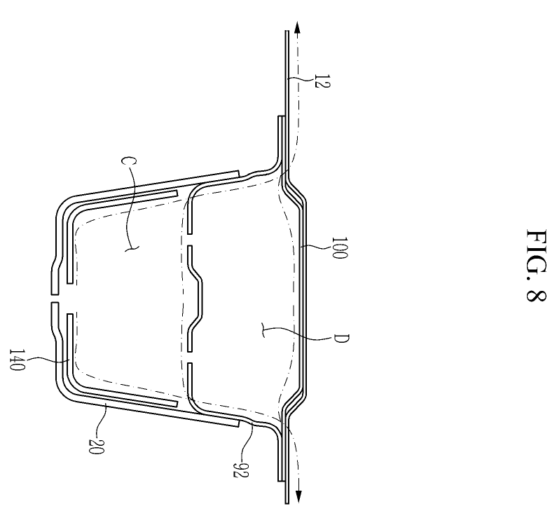

The vehicle body lower structure according to an example embodiment may further include a rear side member front reinforcing portion 140 (shown in at least FIG. 8) provided on the inner side of the rear side member 20 and disposed in front of the trailing arm mounting portion 80. For example, the rear side member front reinforcing portion 140 supports the trailing arm mounting portion 80 and may secure the strength of the rear side member 20 so that a battery mounted on the vehicle body is not damaged.

The trailing arm mounting portion 80 may be formed on a curved portion 26 where the rear side member 20 is formed with an upward inclination in a vehicle body rear direction. The trailing arm mounting portion 80 is formed on the curved portion 26 of the rear side member 20, so space utilization may be increased. In addition, by increasing the strength of the curved part, bending of the rear side member 20 may be minimized (e.g., suppressed) or prevented during a rear collision of the vehicle.

The vehicle body lower structure according to an example embodiment may further include a side member upper reinforcing portion 30 connected to the upper part of the rear side member 20 in the rearward direction of the trailing arm mounting portion 80. The side member upper reinforcing portion 30 supports the rear of the trailing arm mounting portion 80 and may increase vehicle body (e.g., length direction) strength of the rear side member 20.

The side member upper reinforcing portion 30 includes a side member upper reinforcing portion flange 32 curved at the upper part, and the side member upper reinforcing portion flange 32 is connected with the rear floor panel 12 to support the rear floor panel 12.

The trailing arm mounting portion 80 is formed with a double cross-section so that the trailing arm module 120 may be mounted.

As shown in FIG. 7, the rear floor side upper 92 forms an upper module cross-section B together with the seat mounting panel 100 and/or the rear floor panel 12 at the upper part of the trailing arm mounting bracket 82.

The module mount space A formed by the trailing arm mounting bracket 82 and the upper module cross-section B are formed as a double cross-section, that is, a double box cross-section structure, so that a load transmitted from the trailing arm module 120 may be dispersed to the rear side member 20 and the cross member 50.

The rear floor side upper 92 is connected, for example, by welding, to the inner bracket protruding portion 84 of the trailing arm mounting bracket 82 to form a load transmission path of the rear side member 20.

According to the vehicle body lower structure according to an example embodiment, since the strength of the trailing arm mounting portion 80 may be secured, NVH performance may be improved by minimizing or preventing (e.g. suppressing) occurrence of vibration and noise. Through this, torsion of the vehicle body may be suppressed to secure durability performance.

Space utilization may be increased because the trailing arm mounting portion 80 is provided on the inner side of the rear side member 20, and a low-floor platform may be implemented because a position of the rear floor panel 12 may be (e.g., relatively) lowered.

FIG. 8 is a cross-sectional view taken along line VIII-VIII of FIG. 2.

Referring to FIG. 8, the rear side member 20 and the rear floor side upper 92 form a (e.g., one) cross-section structure C inside the rear side member 20, and the rear floor side upper 92 and the seat mounting panel 100 may form another cross-section structure D. That is, the rear side member 20, the rear floor side upper 92, and the seat mounting panel 100 form a double cross-section shape, that is, a double box cross-section structure, to increase the strength of the rear side member 20. In addition, the rear side member front reinforcing portion 140 is connected to the rear side member 20 to support the trailing arm mounting portion 80 and reinforce the strength of the rear side member 20 and prevent damage to a battery mounted on the vehicle body.

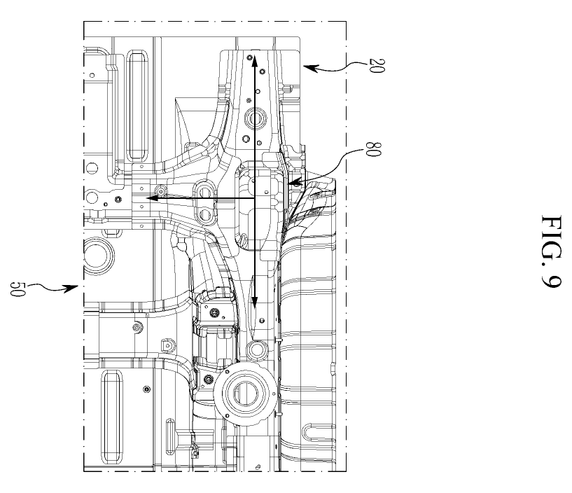

FIG. 9 is a drawing showing load transmission of a vehicle body lower structure according to an example embodiment.

Referring to FIG. 9, at a portion where the rear side member 20 and the cross member 50 are connected, the trailing arm mounting portion 80 is mounted on the inner side of the rear side member 20 to disperse a load transmitted from the trailing arm module 120 to the rear side member 20 and the cross member 50.

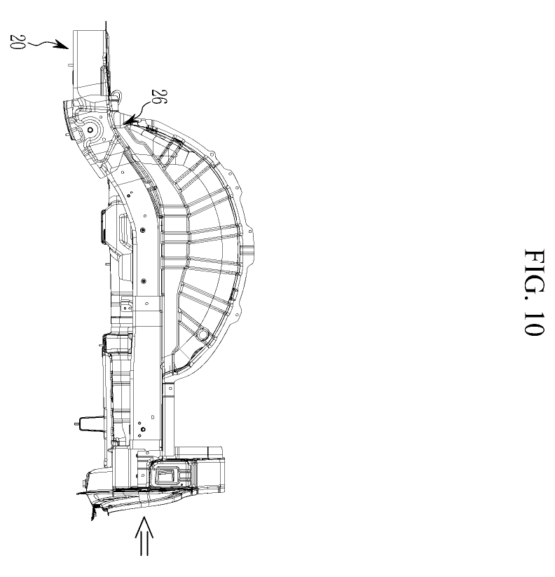

FIG. 10 is a drawing showing an operation of a vehicle body lower structure according to an example embodiment during a collision.

Referring to FIG. 10, the trailing arm mounting portion 80 is formed on the curved portion 26 of the rear side member 20 to increase the strength of the curved portion 26. Even if a load is concentrated on the curved portion 26 during a collision of a vehicle, bending or fracture of the rear side member 20 may be suppressed due to increased strength of the curved portion 26.

The vehicle body lower structure according to an example embodiment, a wide vehicle interior space may be secured by mounting the trailing arm module 120 on the inner side of the rear side member 20.

According to the vehicle body lower structure according to an example embodiment, a low-floor platform may be implemented by mounting the trailing arm module 120 on the inner side of the rear side member 20.

According to the vehicle body lower structure according to an example embodiment, the trailing arm module 120 may be mounted without a separate bracket, so the number of parts may be reduced.

According to the vehicle body lower structure according to an example embodiment, a load transmitted from the trailing arm module 120 may be dispersed to the vehicle body.

While an example embodiment has been described herein, the example embodiment is not limited, and includes (e.g., all) changes within a range that is (e.g., easily) changed and recognized as equivalent by a person of an ordinary skill in the technical field to which an example embodiment of the present disclosure belongs.

What is claimed is:

1. A vehicle body lower structure comprising:
a rear side member disposed in a length direction of a vehicle body;
a cross member connected to the rear side member and positioned in a width direction of the vehicle body; and
a trailing arm mounting portion provided on an inner side of the rear side member, such that the trailing arm mounting portion is on an outside of the vehicle body and in the width direction of the cross member, and the trailing arm mounting portion is formed with a double cross-section to facilitate mounting a trailing arm module.

2. The vehicle body lower structure of claim 1, wherein the trailing arm mounting portion comprises:
a trailing arm mounting bracket connected to the inner side of the rear side member, and the trailing arm module is mounted to the trailing arm module.

3. The vehicle body lower structure of claim 2, wherein
a rear floor side upper is connected to an upper part of the rear side member to form the double cross-section with the trailing arm mounting bracket.

4. The vehicle body lower structure of claim 3, wherein the trailing arm mounting bracket comprises:
a trailing arm inner bracket formed to protrude in a height direction of the vehicle body to provide the trailing arm module.

5. The vehicle body lower structure of claim 4, wherein the trailing arm mounting bracket further comprises:
a trailing arm outer bracket connected to the trailing arm inner bracket to form a module mount space where the trailing arm module is mounted.

6. The vehicle body lower structure of claim 3, further comprising a trailing arm mounting reinforcing portion connected to an outer side of the rear side member at a position corresponding to a position of the trailing arm mounting portion.

7. The vehicle body lower structure of claim 3, wherein the rear floor side upper comprises:
a rear floor side upper connection portion connected to the trailing arm mounting bracket.

8. The vehicle body lower structure of claim 7, wherein the rear floor side upper further comprises:
a rear floor side upper protruding portion formed to protrude in a lower direction of the vehicle body.

9. The vehicle body lower structure of claim 3, wherein the rear floor side upper comprises:
a rear floor side upper front part disposed in a front direction of the vehicle body.

10. The vehicle body lower structure of claim 9, wherein the rear floor side upper further comprises:
a rear floor side upper rear part connected to the rear floor side upper front part and positioned behind the rear floor side upper front part.

11. The vehicle body lower structure of claim 3, further comprising a seat mounting panel connected to an upper part of the rear floor side upper.

12. The vehicle body lower structure of claim 3, further comprising a rear suspension support connecting the trailing arm mounting bracket and the rear side member.

13. The vehicle body lower structure of claim 12, wherein the rear suspension support is positioned from the trailing arm mounting bracket toward the cross member.

14. The vehicle body lower structure of claim 13, wherein the rear suspension support is connected to the inner side of the rear side member.

15. The vehicle body lower structure of claim 1, the cross member includes a cross member extension having a cross-sectional shape, wherein the cross-sectional shape widens toward the trailing arm mounting portion.

16. The vehicle body lower structure of claim 15, wherein the cross member further includes a cross member bulkhead mounted inside the cross member extension.

17. The vehicle body lower structure of claim 1, further comprising a rear side member front reinforcing portion provided on the inner side of the rear side member.

18. The vehicle body lower structure of claim 17, wherein the rear side member front reinforcing portion is positioned in front of the trailing arm mounting portion.

19. The vehicle body lower structure of claim 1, wherein the trailing arm mounting portion is formed on a curved portion where the rear side member is formed with an upward inclination in a vehicle body rear direction.

20. The vehicle body lower structure of claim 19, further comprising a side member upper reinforcing portion connected to an upper part of the rear side member in a rear direction of the vehicle body of the trailing arm mounting portion.
